(19) United States
(12) Patent Application Publication
(10) Pub. No.: US 2007/0267795 A1
(43) Pub. Date: Nov. 22, 2007

(54) Pin clamp transfer assembly and method of transferring a workpiece

(76) Inventors: Parag Patwardhan, Fort Wayne, IN (US); Bruce D. McIntosh, Monroeville, IN (US)

Correspondence Address: BARNES & THORNBURG LLP, 600 ONE SUMMIT SQUARE, FORT WAYNE, IN, 46802, US

(21) Appl. No.: 11/700,660

(22) Filed: Jan. 31, 2007

Related U.S. Application Data
(60) Provisional application No. 60/765,759, filed on Feb. 6, 2006.

(51) Int. Cl. B25B 1/20

(52) U.S. Cl. 269/37; 414/744.4

(57) ABSTRACT

A pin clamp transfer assembly may provide first and second pin clamps. The first pin clamp has a pin that extends from a body with a first end located distal from the body. The second pin clamp also has a pin that extends from a body with a second end located distal from the body. The first end of the first pin is engagable with the second end of the second pin to align the first and second pins. A pin clamp transfer assembly may alternatively have a pin clamp assembly that includes a transfer assist to move a workpiece relative to the pin clamp's pin.

### RELATED APPLICATIONS

The present application is related to and claims priority to U.S. Provisional Patent Application Ser. No. 60/765,759 filed on Feb. 6, 2006, entitled Pin Clamp Assembly Transfer Mechanism & Assembly. The subject matter disclosed in that provisional application is hereby expressly incorporated into the present application by reference.

### TECHNICAL FIELD

The present disclosure relates to pin clamp assemblies and more particularly to a pin clamp transfer assembly and methods of transferring workpieces.

### BACKGROUND AND SUMMARY

Pin clamps as gripping devices are known and are typically identified by their characteristic locating pin selectively extending from the clamp body. The locating pin is typically configured to extend through holes, slots, or cavities in a workpiece, such as a sheet metal panel. A finger or other structure is extendable from the locating pin to assist holding the workpiece in place against a portion of the clamp's body.

Using a pin clamp to transfer a workpiece from one location to another typically requires a first hole used by a first pin clamp to transfer the workpiece to a second pin clamp which uses a different hole to receive the workpiece. Pin clamps also lack the ability to engage or otherwise interact with each other to accomplish a particular task. It would be useful for pin clamps of particular configuration to engage each other to accomplish useful tasks such as moving a workpiece.

Accordingly, an illustrative embodiment of the present disclosure provides a pin clamp transfer assembly which comprises first and second pin clamps. The first pin clamp comprises a pin that extends from a body and has a first end located distal from the body and a first extendable finger. The second pin clamp comprises a pin that extends from a body and has a second end located distal from the body and a second extendable finger. The first end of the first pin is engagable with the second end of the second pin to align the first and second pins.

In the above and other illustrative embodiments, the pin clamp transfer assembly may also comprise: the pins of the first and second pin clamps being each locating pins; the first end further comprising a wall extending therefrom being engagable with a protrusion extending from the second end; the protrusion includes a portion of a radius ball that engages periphery wall; the first and second ends have connectable geometries to align the pins; further comprising a transfer assembly being attachable to either the first or second pin clamp and comprises a base configured to be located adjacent the pin and receive a portion of a workpiece; the base being movable relative to the pin and configured to move the workpiece relative to the pin; the transfer assembly further comprising an actuator that moves the base between the pins of the first and second pin clamps; a clamping surface configured to be received in a cutout formed in the base of the transfer assembly; the pins of the first and second pin clamps face each other; and the first and second ends of the first and pins are chamfered.

Another illustrative embodiment provides a pin clamp transfer assembly which also comprises first and second pin clamps. The first pin clamp assembly comprises a pin that extends from a body and has a first end located distal from the body. The second pin clamp assembly comprises a pin that extends from a body and has a second end located distal from the body. The first end of the first pin has a receptacle, the second end of the second pin has a protrusion and is configured to engage the receptacle of the first pin to coaxially align the first and second pins.

In the above and other illustrative embodiments, the pin clamp transfer assembly may also comprise the first pin having a first finger extendable therefrom, and the second pin having a second finger extendable therefrom.

Another illustrative embodiment provides a pin clamp transfer assembly which also comprises a pin clamp assembly and a transfer assembly. The pin clamp assembly comprises a pin that extends from a body. The pin has an end located distal from the body and a finger that is extendable from the pin. The transfer assembly comprises an actuator and a base. The base is located adjacent the pin and the actuator moves the base relative to the pin.

In the above and other illustrative embodiments, the pin clamp transfer assembly may also comprise: the transfer assembly being coupled to the pin clamp assembly; the base being movable beyond the end of the pin distal from the body; the base being configured to receive a workpiece that can be held by the extended finger, and the base being configured to move the workpiece that is released by the retracted finger; the base further comprising at least one suction cup that assists holding the workpiece; and the base further comprising a magnet that assists holding the workpiece.

Another illustrative embodiment provides a method of transferring a workpiece, the method comprising the steps of: providing a first and second pin clamp assemblies each comprising a pin that extends from a body, each pin having an end located distal from the body and a finger extendable from the pin; providing a transfer assembly comprising an actuator and a base, wherein the base is located adjacent the pin of the first clamp assembly and the actuator moves the base relative to the pin of the first clamp assembly; positioning the pins of the first and second pin clamps towards each other; coupling the ends of the pins of the first and second pin clamps; retracting the finger of the first pin clamp; extending the base of the transfer assembly along the coupled ends of the pins of the first and second pin clamps; and extending the finger of the second pin clamp.

In the above and other illustrative embodiments, the method further comprises the steps of: providing a receptacle in the end of the pin of the first pin clamp assembly which is engagable with a protrusion extending from the end of the pin of the second pin clamp assembly; providing a receptacle in the end of the pin of the second pin clamp assembly which is engagable with a protrusion extending from the end of the pin of the first pin clamp assembly; extending the base of the transfer assembly along the coupled ends of the pins of the first and second pin clamps against the weight of gravity; providing a coupling means on the base when extending it along the coupled ends of the pins of the first and second pin clamps; separating the ends of the pins of the first and second pin clamps after transfer of the workpiece; and coupling of pins of the first and second pin clamps in coaxial alignment.

Another illustrative embodiment provides a method of transferring a workpiece, the method comprising the steps of: providing first and second pin clamps each comprising a pin that extends from a body, each pin having an end located distal from the body and a finger extendable from the pin; positioning the pins of the first and second pin clamps towards each other; coupling the ends of the pins of the first and second pin clamps; retracting the finger of the first pin clamp; and extending the finger of the second pin clamp.

Additional features and advantages of the pin clamp transfer assembly and method will become apparent to those skilled in the art upon consideration of the following detailed description of the illustrated embodiment exemplifying the best mode of carrying out the pin clamp transfer assembly and method as presently perceived.

### BRIEF DESCRIPTION OF DRAWINGS

The present disclosure will be described hereafter with reference to the attached drawings which are given as non-limiting examples only, in which:

FIGS. 1a and b are perspective in detail views of a matable pin clamp assembly;

FIGS. 2a and b are also perspective in detail views of a pin clamp assembly that is matable with the pin clamp assembly of FIGS. 1a and b;

FIGS. 3a and b are side elevational and detail views of mating or joined pin clamp assemblies;

FIGS. 4a and b are perspective views of pin clamp assemblies with a transfer assist located in extended and retracted positions;

FIGS. 5a-c are progressive perspective views demonstrating an illustrative utility of the transfer assist;

FIGS. 6a-c are perspective views of other illustrative embodiments of transfer assists and pin clamp assemblies;

FIGS. 7a and b are illustrative embodiments of a transfer head;

FIGS. 8a and b are perspective and side elevation views of an illustrative embodiment of a pin clamp transfer assembly;

FIGS. 9a-d are illustrative progression views of the pin clamp transfer assembly transferring a workpiece from an upper pin clamp to a lower pin clamp; and

FIGS. 10a-c are further progression views of the pin clamp transfer assembly and transferred workpiece from FIGS. 9a-d.

Corresponding reference characters indicate corresponding parts throughout the several views. The exemplification set out herein illustrates embodiments of the pin clamp transfer assembly and method, and such exemplification is not to be construed as limiting the scope of the pin clamp transfer assembly and method in any manner.

### DETAILED DESCRIPTION OF THE DRAWINGS

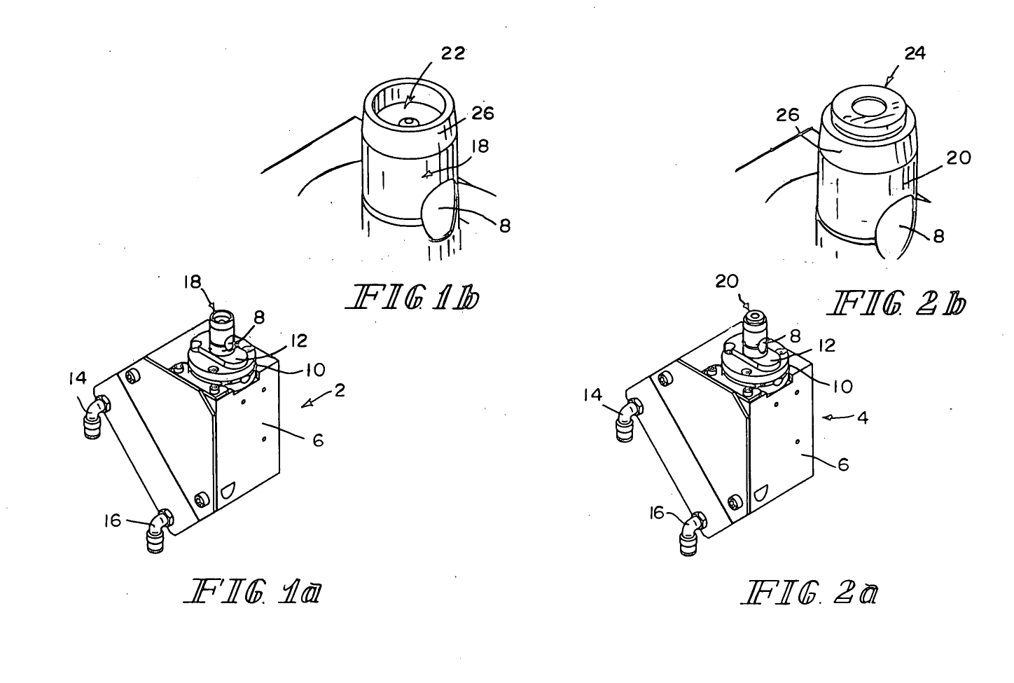

Perspective and detail views of mating pin clamps 2 and 4 are shown in FIGS. 1a, b and 2a, b, respectively. Both clamp assemblies are similar with respect to their illustrative bodies 6, as well as their mode of operation to extend and retract fingers 8. Both clamp assemblies 2 and 4 comprise a collar 10 having a clamping surface 12 located thereon. Also shown in these views are fluid ports 14 and 16. It is appreciated that the pin clamp structures can be modified and, in alternate embodiments, be of a variety of configurations.

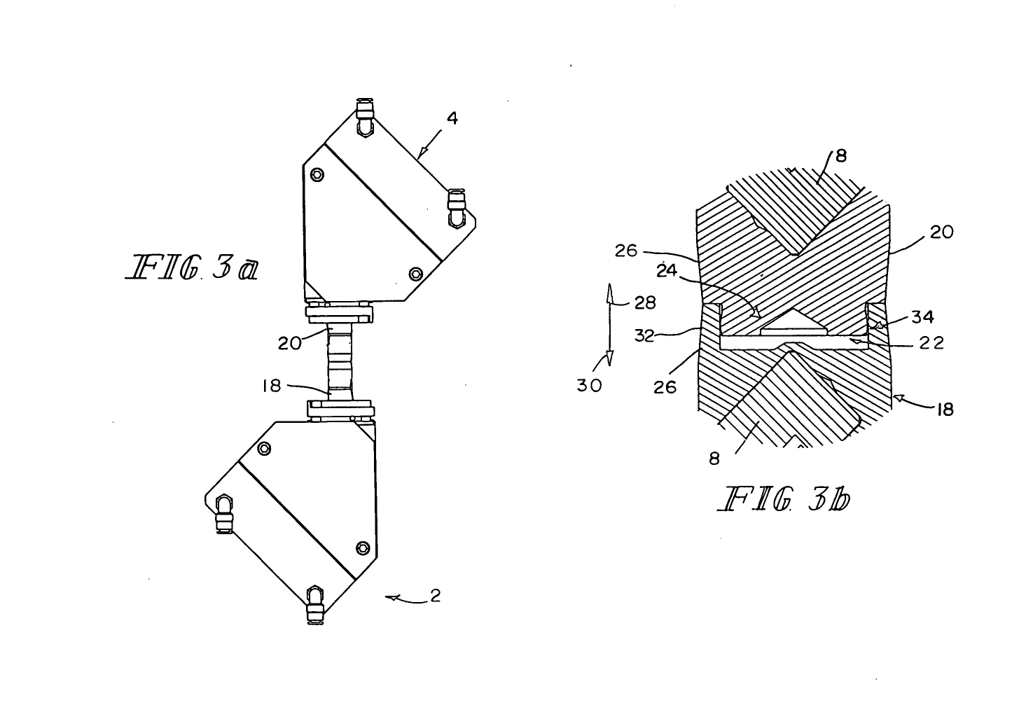

A distinction between pin clamps 2 and 4 is their locating pins 18 and 20, respectively, as indicated by the corresponding detail views of FIGS. 1b and 2b. Both locating pins 18 and 20 of clamp assemblies 2 and 4, respectively, are configured to extend into a cavity, slot, hole, or other similar cavity or opening in a workpiece during the clamping operation. In contrast to prior art designs, locating pins 18 and 20 have mating female and male geometries at their distal ends. The ends engage each other to provide alignment of locating pins 18 and 20 during transfer of the workpiece between the two clamps, as described further herein. As shown, locating pin 18 comprises a shallow cavity 22 having a geometry configured to mate with the corresponding geometry of protruding end 24 of pin 20. It is appreciated that the mating components on each locating pin shown are illustrative. Other geometries could be used, such as a ball and cylinder, tongue and groove, cone and recess, a keyed shaft and keyed hole, etc. The objective is that the ends of the locating pins serve to align the same and achieve a fixed axial distance between the ends of the pins. Illustratively, each locating pin may further comprise a chamfer 26 to assist the workpiece in sliding along the pins 18 and 20.

The operation of pin clamps like pin clamps 2 and 4 is described in U.S. patent application Ser. No. 11/505,533, filed on Aug. 17, 2006, entitled “Pin Clamp Assembly.” This disclosure is herein expressly incorporated into this present application by reference. For example, an illustrative operation of finger 8 herein is described in the referring application.

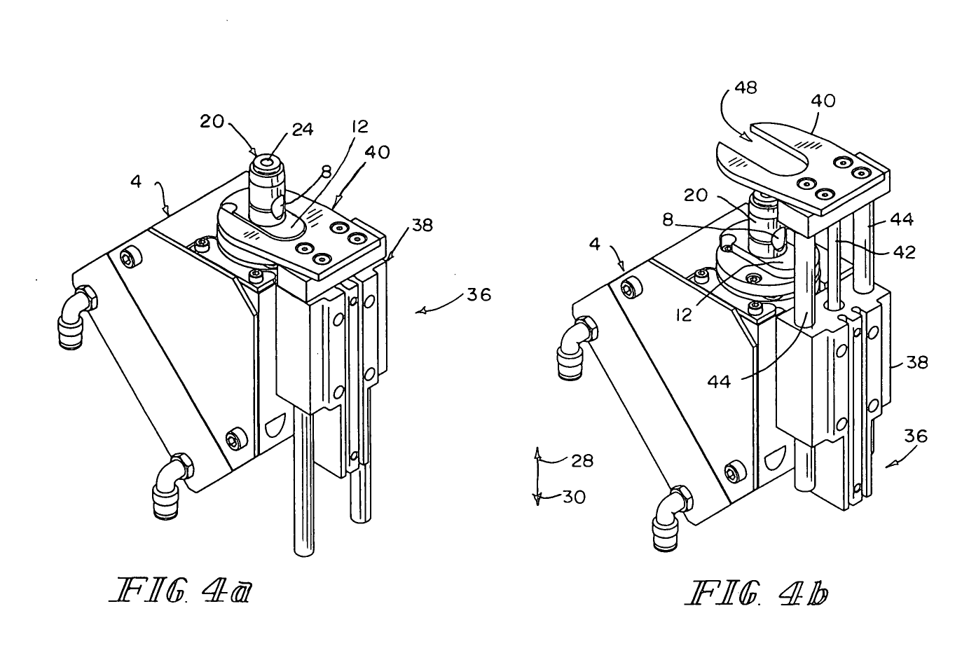

A side elevational view of pin clamps 2 and 4, oriented and joined in an illustrative transfer configuration, as well as a detail view of the mating of locating pins 18 and 20, are shown in FIGS. 3a and b, respectively. In the view shown in FIG. 3a, pin clamp 2 is oriented so locating pin 18 is directed upwardly in direction 28 and pin clamp 4 is oriented so its locating pin 20 is oriented downwardly in direction 30. In addition, locating pins 18 and 20 are shown mated in an essentially axially-aligned arrangement. It can be appreciated from this view that if locating pin 18 is disposed through the hole of a workpiece, the mating with locating pin 20 allows the workpiece to move upward and downward in directions 28 and 30 along the length of both locating pins 18 and 20.

As shown in the detail view of FIG. 3b, the cross-sectional view of locating pins 18 and 20 depict how they mate together. In this illustrative embodiment, cavity 22 comprises a periphery wall 32 configured to engage periphery 34 at end 24 of locating pin 20. As shown in this view, periphery 34 is a portion of a radius ball that provides sufficient coupling to cavity 22 by engaging its periphery walls 32. This view also shows the illustrative orientation of fingers 8 in both locating pins 18 and 20. Furthermore, illustrative chamfers 26 are shown located on each pin 18 and 20. Chamfers 26 reduce the diameter of locating pins 18 and 20, respectively, so that any seam formed by the engagement of cavity 22 and end 24 does not obstruct travel of the workpiece moving between the two locating pins. It is appreciated from this view how cavity 22 and end 24 can be structurally modified, yet can still serve to mate and align locating pins 18 and 22.

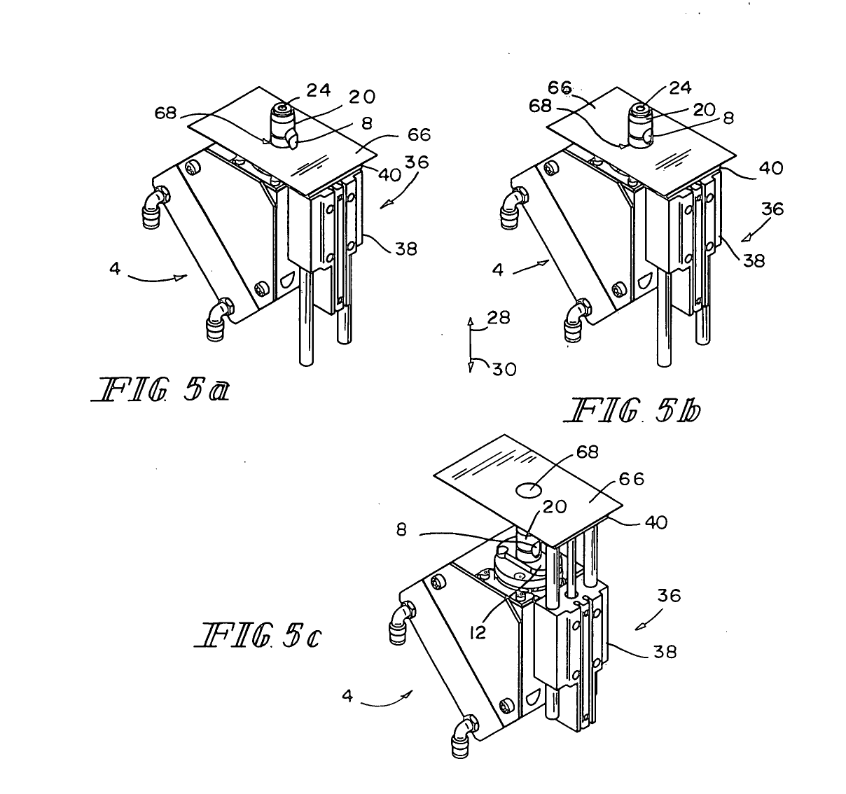

Perspective views of pin clamp assembly 4, having a transfer assist 36 attached thereto, are shown in FIGS. 4a and b. As shown in FIG. 4a, transfer assist 36 comprises an illustrative slide assembly 38 coupled to a transfer head 40 which is movable relative thereto. A utility of transfer assist 36 is to help transfer the workpiece from one pin clamp to another. It is appreciated that transfer assist 36 can be attached to either pin clamps 2 or 4, which themselves can be oriented as either the top or bottom pin clamp. In an illustrative embodiment, slide 38 is a pneumatic slide that extends transfer head 40 via a piston assembly moving piston rod 42 and guides 44 as shown in FIG. 4b. It is appreciated, however, that the mechanism for moving transfer head 40 can be electrical, mechanical, or hydraulic, for example. In addition, the embodiment shown herein is but one of a variety of mechanisms that can move transfer head 40.

With respect to transfer head 40, the embodiment shown is positionable about clamping surface 12. In the illustrated embodiment, transfer head 40 comprises a cutout 48 that is configured to receive clamping surface 12 which itself is illustratively configured to support the workpiece. Transfer head 40 is configured to lift the workpiece from clamping surface 12 in direction 28. It is contemplated that when this happens, finger 8 is retracted and any workpiece resting on transfer head 40 is lifted so finger 8 of the opposed pin clamp can extend to grasp and hold the workpiece. Furthermore finger 8, even if extended, illustratively does not interfere with the movement of transfer head 40. It is appreciated, that transfer head 40 shown is of illustrative design, and it can be easily ascertained by one skilled in the art that the disclosure herein encompasses transfer heads of other varieties, so long as they assist in moving the workpiece from one pin clamp assembly to another.

Other illustrative embodiments of the transfer assist may comprise a linear motor attached to the pin clamp or other device. Alternative embodiments may further comprise an electric motor with a lead screw mechanism or a spring-loaded cylinder to transfer or move the workpiece. In still another embodiment, the transfer assist may be used without the locating pins being aligned with each other. For example, the transfer assist can lift the workpiece passed the top of the locating pin making the hole available for use by a subsequent pin clamp, or by another device that can engage the hole.

Progressive perspective views of an illustrative utility of pin clamp assembly 4 having a transfer assembly 36 attached thereto, are shown in FIGS. 5a-c. It is appreciated that although pin clamp assembly 4 is shown, pin clamp 2 could be interchanged in its stead. These views demonstrate how transfer assembly 36 can be configured to move a sheet metal panel 66 having a hole 68 disposed therethrough to an extended position beyond locating pin 20 making hole 68 available for transfer to another pin clamp assembly or another device altogether. This figure illustratively demonstrates that an opposing pin clamp assembly does not need to line-up and engage locating pin 20, in an alternate embodiment. Furthermore, hole 68 of sheet metal panel 66, being exposed and not obstructed by locating pin 20, allows sheet metal panel 66 to be available for any variety of subsequent operations or transfers. As shown in FIG. 5a, locating pin 20 is disposed through hole 68 with finger 8 engaging sheet metal panel 66. To move sheet metal panel 66, it becomes unclamped by finger 8 which is retracted into locating pin 20 as depicted in FIG. 5b. Transfer head 40 can then be lifted via slide assembly 38 to lift sheet metal panel 66 on transfer head 40, upward in direction 28 and over locating pin 20. By clearing hole 68 from locating pin 20, hole 68 is now available to be received by another locating pin clamp or other mechanism.

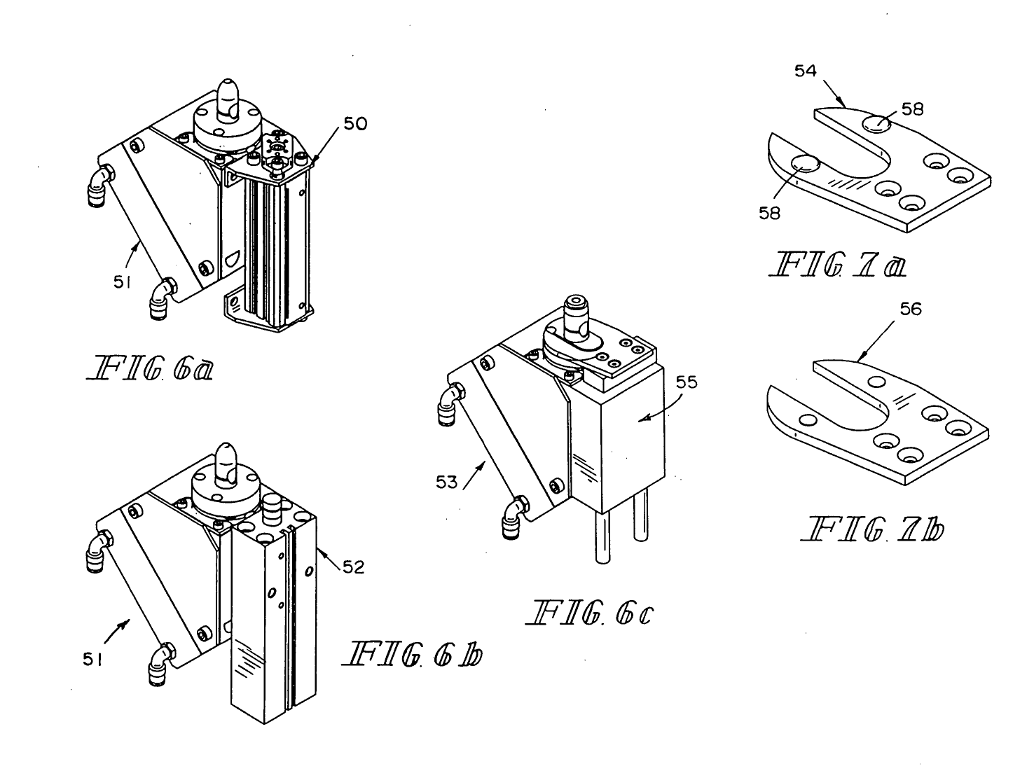

Perspective views of an illustrative pin clamp assembly 51, with a twin rod cylinder actuator 50 and a bolt-on custom actuator 52, are shown in FIGS. 6a, and b, respectively. Pin clamp 53 of FIG. 6c comprises an integrally-formed actuator 55. These views demonstrate how a variety of actuators can be used to serve as a transfer assists for transfer head 40. It is appreciated that the construction of the pin clamp assembly 51 can be modified to accommodate a transfer assist of different varieties. In an alternate embodiment, it is not required that the transfer assist be strictly attached to the pin clamp. Rather, the transfer assist may be spaced apart from the pin clamp, yet assist moving the workpiece from the pin clamp.

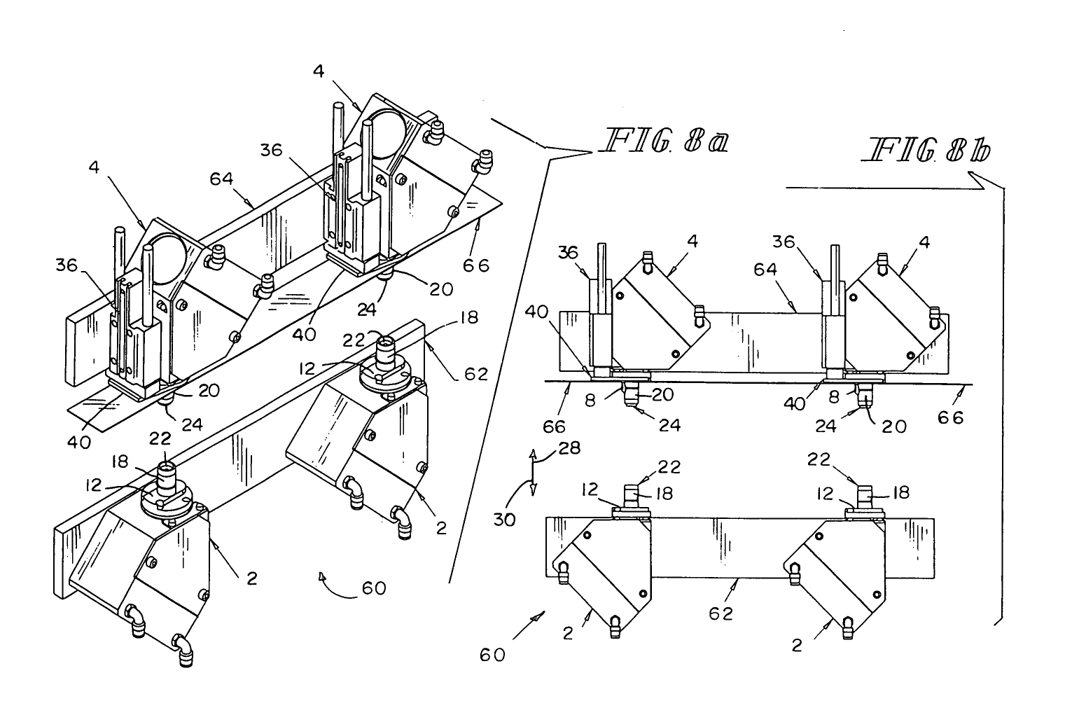

It is further contemplated that in situations where a workpiece will be transferred from an upper pin clamp to a lower pin clamp, or other situations where gravity may be an issue, the transfer head can be modified to accommodate this use. For example, alternate embodiments of transfer heads 54 and 56 are shown in FIGS. 7a and b, respectively. As shown in FIG. 7a, transfer head 54 comprises suction cups 58 that can be used to hold the workpiece against gravity to produce a controlled transfer of the workpiece from the locating pin. Similarly, as shown in FIG. 7b, transfer head 56 can be magnetized to hold the workpiece to produce a controlled transfer of the same.

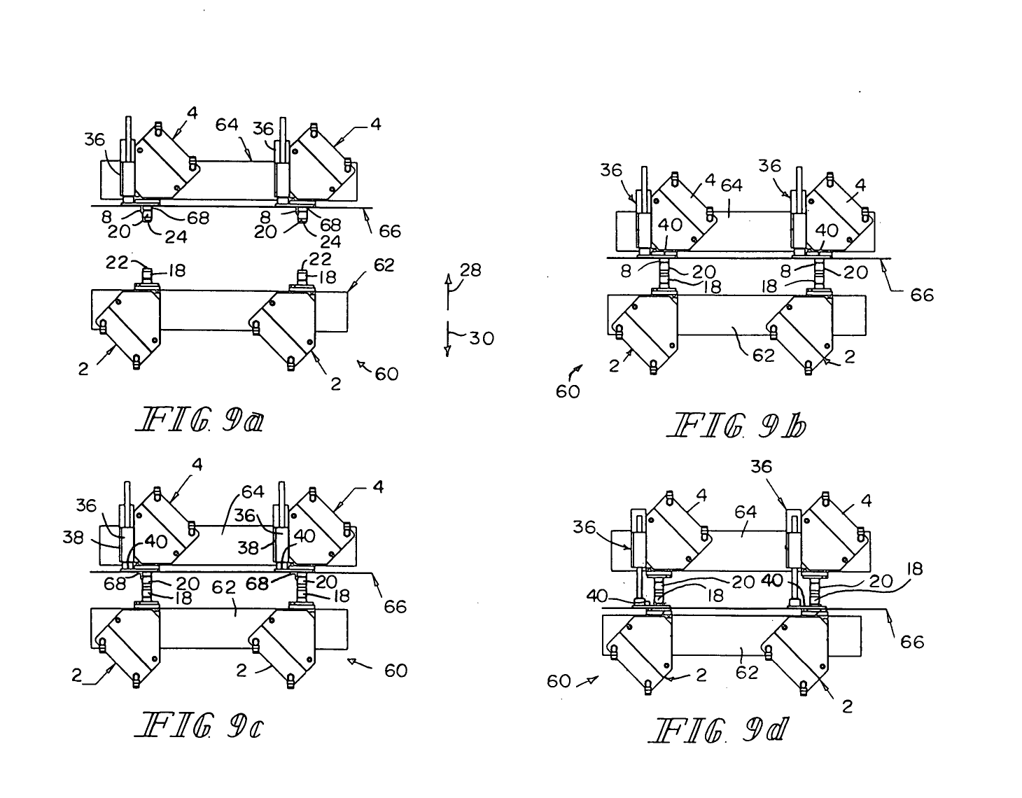

Perspective and side-elevation views of a pin clamp transfer mechanism assembly 60 are shown in FIGS. 8a and b, respectively. It is appreciated that transfer mechanism assembly 60 is an illustrative embodiment and that other arrangements of pin clamps would be easily ascertainable to those skilled in the art upon disclosure of this illustrative embodiment. As shown in FIG. 8a, transfer mechanism assembly 60 comprises pin clamps 2 having locating pins 18 extending therefrom incorporating cavities 22. Pin clamps 2 are attached to an illustrative first plate 62. Located above pin clamps 2 are pin clamps 4 attached to second plate 64 and having transfer assist assemblies 36 attached thereto. Locating pins 20, with protruding ends 24, are illustratively positioned opposite cavities 22 of pin clamps 2. A workpiece in the form of sheet metal panel 66 is held by pin clamps 4. As shown in FIG. 8b, fingers 8 extend outward from locating pins 20 which hold sheet metal panel 66 against clamping surface 12 of each pin clamp 4. As this view also shows, transfer assists 36 have transfer heads 40 attached thereto configured to engage sheet metal panel 66. This view also shows the relative positioning of pin clamps 2 with respect to pin clamps 4. It is appreciated, however, that this is simply illustrative, and in other embodiments, there is no requirement that locating pins 18 of pin clamps 2 be lined up with locating pins 20 of pin clamps 4 prior to the transfer process. This view also shows an illustrative spacing between pin clamps 2 and 4 in that either clamps may be movable in directions 28 and 30 to achieve the desired engagement.

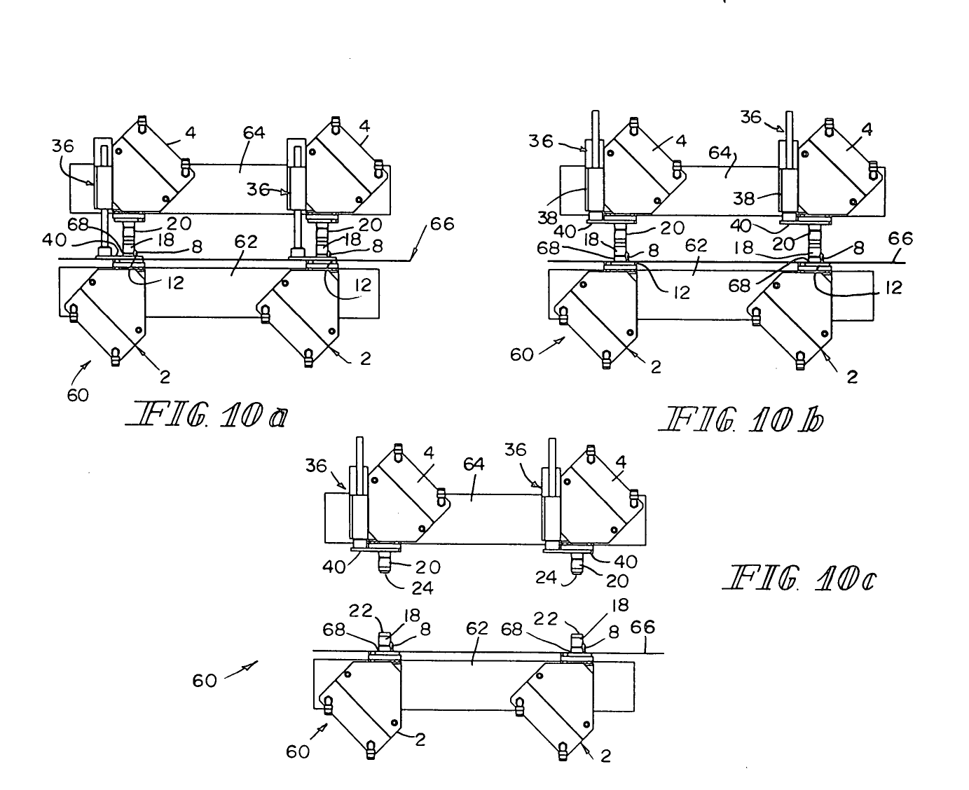

An illustrative process of transferring sheet metal panel 66 from the upper pin clamps 4 to the lower pin clamps 2 using the same holes 68 disposed in sheet metal panel 66 is shown in FIGS. 9a-d and FIGS. 10a-c. The views of FIGS. 9a-d show how sheet metal panel 66 is moved from pin clamps 4 to pin clamps 2. For example, as shown in FIG. 9a locating pins 18 and 20 of pin clamps 2 and 4 are generally aligned opposite each other. This can be accomplished via robots or other means known to those skilled in the art of moving clamps, grippers, and actuators, for example. As shown, cavities 22 are positioned generally opposite of ends 24. It is appreciated that first and second plates 62 and 64 can be moved to provide the proper alignment between locating pins 18 and 20. As shown in FIG. 9b, more precise alignment is made between the pin clamps 2 and 4 by moving the same, illustratively via plates 62 and 64 in either directions 28 and 30 and/or laterally so that locating pins 18 and 20 engage. Also shown in this view is end 24 of locating pin 20 engaged with cavity 22 of locating pin 18. Illustratively, the locating pins become axially-aligned.

Once locating pins 18 and 20 are aligned, fingers 8 that held sheet metal panel 66 against pin clamp 4 are now retracted, as shown in FIG. 9c. It is appreciated that, depending on the objective of the mechanism, sheet metal panel 66 may be free to drop onto pin clamps 2 via gravity. In the illustrated embodiment, transfer heads 40 may be configured with suction cups or magnets such as those discussed in FIGS. 7a and b. Such a configuration may prevent sheet metal panel 66 from outright falling so the transfer can be more deliberate or controlled. As shown in FIG. 9d, slides 38 extend downwardly in direction 30 to lower sheet metal panel 66 from locating pin 20 to locating pin 18. It is appreciated from this view how sheet metal panel 66 has just been transferred from pin clamp 4 to pin clamp 2 using a single set of pin holes. This is in contrast to providing a second set of holes or slots for locating pins 18.

It is appreciated that in another embodiment, to transfer sheet metal panel 66 from lower pin clamps 2 to upper pin clamps 4, transfer assists 36 can be attached to pin clamps 2. The transfer assists can then lift sheet metal panel 66 up to pin clamps 4.

The views shown in FIGS. 10a-c are an illustrative continuation of the process described in FIG. 9. Accordingly, once transfer assemblies 36 have positioned sheet metal panel 66 onto pin clamps 2, fingers 8 extend from locating pins 18 to hold sheet metal panel 66 against the clamping surface 12. Then, as shown in FIG. 10b, slides 38 retract transfer heads 40. This completes the transfer of sheet metal panel 66 from pin clamps 4 to pin clamps 2. Finally, the view shown in FIG. 10c simply depicts pin clamps 2 and 4 being separated again by acting on plates 62 and 64. The distinction between this view and the view of FIG. 9a, is that now pin clamps 2 are holding sheet metal panel 66, rather than pin clamps 4.

Corresponding reference characters indicate corresponding parts throughout the several views. Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A pin clamp transfer assembly comprising:
a first pin clamp which comprises a pin that extends from a body and has a first end located distal from the body and has a first extendable finger;
a second pin clamp which comprises a pin that extends from a body and has a second end located distal from the body and has a second extendable finger;
wherein the first end of the first pin is engagable with the second end of the second pin to align the first and second pins.

2. The pin clamp transfer assembly of claim 1, wherein the pins of the first and second pin clamps are each locating pins.

3. The pin clamp transfer assembly of claim 1, wherein the first end further comprises a wall extending therefrom which is engagable with a protrusion extending from the second end.

4. The pin clamp transfer assembly of claim 3, wherein the protrusion includes a portion of a radius ball that engages periphery wall.

5. The pin clamp transfer assembly of claim 1, wherein the first and second ends have connectable geometries to align the pins.

6. The pin clamp transfer assembly of claim 1, further comprising a transfer assembly that is attachable to either the first or second pin clamp and comprises a base configured to be located adjacent the pin and receive a portion of a workpiece; the base is movable relative to the pin and is configured to move the workpiece relative to the pin.

7. The pin clamp transfer assembly of claim 6, wherein the transfer assembly further comprises an actuator that moves the base between the pins of the first and second pin clamps.

8. The pin clamp transfer assembly of claim 6, further comprising a clamping surface configured to be received in a cutout formed in the base of the transfer assembly.

9. The pin clamp transfer assembly of claim 1, wherein the pins of the first and second pin clamps face each other.

10. The pin clamp transfer assembly of claim 6, wherein the first and second ends of the first and second pins are chamfered.

11. A pin clamp transfer assembly comprising:
a first pin clamp which comprises a pin that extends from a body and has a first end located distal from the body;
a second pin clamp which comprises a pin that extends from a body and has a second end located distal from the body;
wherein the first end of the first pin has a receptacle, the second end of the second pin has a protrusion configured to engage the receptacle of the first pin to align the first and second pins.

12. The pin clamp transfer assembly of claim 11, wherein the first pin has a first finger extendable therefrom, and the second pin has a second finger extendable therefrom.

13. A pin clamp transfer assembly comprising:
a pin clamp which comprises a pin that extends from a body, the pin has an end located distal from the body and a finger that is extendable from the pin;
a transfer that comprises an actuator and a base, wherein the base is located adjacent the pin and the actuator moves the base relative to the pin;

14. The pin clamp transfer assembly of claim 13, wherein the transfer assembly is coupled to the pin clamp.

15. The pin clamp transfer assembly of claim 13, wherein the base is movable beyond the end of the pin distal from the body.

16. The pin clamp transfer assembly of claim 15, wherein the base is configured to receive a workpiece that can be held by the extended finger and the base is configured to move the workpiece that is released by the retracted finger.

17. The pin clamp transfer assembly of claim 13, wherein the base further comprises at least one suction cup that assists holding the workpiece.

18. The pin clamp transfer assembly of claim 13, wherein the base further comprises a magnet that assists holding the workpiece.

19. A method of transferring a workpiece with at least one hole disposed therein, the method comprising the steps of:
providing first and second pin clamps each comprising a pin that extends from a body, each pin having an end located distal from the body and a finger extendable from the pin;
providing a transfer assembly comprising an actuator and a base, wherein the base is located adjacent the pin of the first clamp and the actuator moves the base relative to the pin of the first clamp assembly;
positioning the pins of the first and second pin clamps towards each other;
coupling the ends of the pins of the first and second pin clamps;
retracting the finger of the first pin clamp;
extending the base of the transfer assembly along the coupled ends of the pins of the first and second pin clamps; and
extending the finger of the second pin clamp.

20. The method of transferring a workpiece of claim 19, further comprising the step of providing a receptacle in the end of the pin of the first pin clamp which is engagable with a protrusion extending from the end of the pin of the second pin clamp assembly.

21. The method of transferring a workpiece of claim 19, further comprising the step of providing a receptacle in the end of the pin of the second pin clamp which is engagable with a protrusion extending from the end of the pin of the first pin clamp.

22. The method of transferring a workpiece of claim 19, further comprising the step of extending the base of the transfer assembly along the coupled ends of the pins of the first and second pin clamps against the weight of gravity.

23. The method of transferring a workpiece of claim 19, further comprising the step of providing a coupling means on the base when extending it along the coupled ends of the pins of the first and second pin clamps.

24. The method of transferring a workpiece of claim 19, further comprising the step of separating the ends of the pins of the first and second pin clamps after transfer of the workpiece.

25. The method of transferring a workpiece of claim 19, further comprising the step of coupling of pins of the first and second pin clamps in coaxial alignment.

26. A method of transferring a workpiece, the method comprising the steps of:
providing first and second pin clamps each comprising a pin that extends from a body, each pin having an end located distal from the body and a finger extendable from the pin;
positioning the pins of the first and second pin clamps towards each other;
coupling the ends of the pins of the first and second pin clamps;
retracting the finger of the first pin clamp; and
extending the finger of the second pin clamp.
